(19) United States
(12) Patent Application Publication
(10) Pub. No.: US 2026/0019115 A1
(43) Pub. Date: Jan. 15, 2026

(54) BIASING RADIO FREQUENCY CIRCUITS WITH DIGITAL CONTROLS

(71) Applicant: Viasat, Inc., Carlsbad, CA (US)

(72) Inventors: Steven J. Franson, Scottsdale, AZ (US); Robert R. Kost, Chandler, AZ (US)

(21) Appl. No.: 18/994,381

(22) PCT Filed: Jul. 14, 2022
(86) PCT No.: PCT/US2022/037123

§ 371 Date: Jan. 14, 2025

(51) Int. Cl. H04B 7/06

(52) U.S. Cl. CPC H04B 7/0617

(57) ABSTRACT

Methods, systems, and devices for biasing radio frequency (RF) circuits with digital controls are described. An example antenna subsystem may include a plurality of beamforming circuits configured to adjust component RF signals for antenna elements. Each beamforming circuit may include phase shifters, amplifiers, and a supply input for the amplifiers. The antenna subsystem may further include a programmable digital device comprising a beam steering input and a control mode input. The antenna subsystem may further include a plurality of digital outputs, including a first set configured to provide phase adjustment control signals to the phase shifters of at least a subset of the beamforming circuits based at least in part on a beam direction value and a second set configured to directly power supply inputs of the subset of the plurality of beamforming circuits based at least in part on a control mode value.

### CROSS REFERENCE

The present Application is a 371 national phase filing of International Patent Application No. PCT/US2022/037123 by FRANSON et al., entitled, “BIASING RADIO FREQUENCY CIRCUITS WITH DIGITAL CONTROLS” filed Jul. 14, 2022, assigned to the assignee hereof, and expressly incorporated by reference in its entirety herein.

### BACKGROUND

The following relates to radio frequency (RF) circuits, and more specifically to techniques for biasing RF circuits with digital controls.

In satellite or other antenna systems, phased antenna arrays may be used for particular applications, where the beam of signals can be steered electronically in any direction without physically moving the antenna. The antenna includes an array of regularly spaced small antennas each with a separate feed. The beam is steered electronically using bias circuitry to control the phase of the radio waves transmitted and received by each of the multiple radiating elements in the antenna. For phased array technology, reducing size, weight, and power (SWAP) of the bias circuitry that controls the antenna array presents challenges, particularly for space applications but also for terrestrial applications.

### SUMMARY

The described techniques relate to improved methods, systems, devices, and apparatuses that support techniques for biasing radio frequency circuits with digital controls. Generally, the described techniques provide for switchable power distribution for an RF antenna array that enables selective powering of separate circuits used for beamsteering, such as a monolithic microwave integrated circuit (MMIC) or another type of monolithic integrated circuit, in a low size, weight, and power (SWAP) configuration. The techniques and apparatus described herein may employ flight qualified components, while not adding additional components for the selective powering of the beamsteering circuits. In some cases, outputs of a programmable digital device (e.g., field programmable gate array (FPGA)) are used to create multiple drain bias outputs for an electronically steered antenna (ESA). The programmable digital device outputs may supply switchable drain currents, using digital outputs generally adapted for outputting digital logic values (e.g., “ones” and “zeros”) to high-impedance inputs of other digital devices. The techniques described herein may enable digital outputs to supply drain bias inputs of the beamsteering circuits. Ultra-low-power (e.g., sub-5 milliwatt (mW)) beamsteering circuits may be used with the techniques described herein. The techniques described herein may also provide full control of an antenna array, without adding additional circuitry or drawing excess current to power a separate switching circuit. In some examples, a programmable digital device such as an FPGA is already part of the ESA control design.

### BRIEF DESCRIPTION OF THE DRAWINGS

FIG. 1 illustrates an example of an antenna subsystem that supports biasing radio frequency circuits with digital controls in accordance with aspects of the present disclosure.

FIG. 2 illustrates a side view of an example of a device that supports biasing radio frequency circuits with digital controls in accordance with aspects of the present disclosure.

FIG. 3 illustrates an example of a device that supports biasing radio frequency circuits with digital controls in accordance with aspects of the present disclosure.

FIG. 4 illustrates an example of a MMIC that supports biasing radio frequency circuits with digital controls in accordance with aspects of the present disclosure.

FIG. 5 illustrates an example circuit diagram for a device that supports biasing radio frequency circuits with digital controls in accordance with aspects of the present disclosure.

FIG. 6 illustrates an example of a device that supports biasing radio frequency circuits with digital controls in accordance with aspects of the present disclosure.

FIG. 7 shows a block diagram of an antenna subsystem that supports biasing radio frequency circuits with digital controls in accordance with aspects of the present disclosure.

FIGS. 8 and 9 show flowcharts illustrating methods that support biasing radio frequency circuits with digital controls in accordance with aspects of the present disclosure.

### DETAILED DESCRIPTION

Phased antenna arrays may work at very high frequencies, with ultra-low power devices with a very small form factor being desired in some cases. The described techniques relate to improved methods, systems, devices, and apparatuses that support techniques for biasing radio frequency circuits with digital controls. Generally, the described techniques provide for switchable power distribution for an RF antenna array that enables selective powering of separate circuits (e.g., monolithic microwave integrated circuits (MMICs)) used for beamsteering, in a low size, weight, and power (SWAP) configuration, and without the use of separate switches for selective powering of the beamsteering circuits. The techniques and apparatus described herein can fit into a very small space and may use commercially available and flight qualified components. In some cases, outputs of a programmable digital device (e.g., field programmable gate array (FPGA)) may be used to create multiple drain bias outputs for an ESA. The programmable digital device outputs may supply switchable drain currents, using digital outputs generally adapted for outputting digital logic values (e.g., “ones” and “zeros”) to high-impedance inputs of other digital devices. The techniques described here may be employed with low-power (e.g., sub-5 milliwatt (mW)) beamsteering circuits (e.g., MMICs), with digital outputs that supply drain bias inputs of the beamsteering circuits. The techniques described herein also provide full control of an antenna array, without adding additional circuitry or drawing excess current to power a separate switching circuit.

For example, a beamforming board (e.g., one or more printed circuits boards generally less than 20 cm, 15 cm, 10 cm or 5 cm on a side) may have a small form factor while including a programmable digital device (e.g., an FPGA), one or more micro-controllers, and one or more beamforming circuits (e.g., beamforming MMICs) for a phased antenna array. In some examples, the beamforming board may include an array of antennas on one side. The programmable digital device may provide direct current (DC) biases to the beamforming circuits, in order to control the phased antenna array. The digital outputs of the programmable digital device may be used to provide drain voltages to power on or off antenna elements via the beamforming circuits. Because the amplifiers in the beamforming circuits are of low power, the beamforming circuits may have a supply input (e.g., supply for drain bias of the amplifier) run off a digital output of the programmable digital device. This enables the drain voltages to be programmable, resulting in full control over the antenna array while saving space on the beamforming board by utilizing some components on the board for supplying power without requiring additional components (on the beamforming board or external to the board) to power the beamforming circuits.

The techniques described herein enable the antenna gain and power consumption to be adjusted. For example, the more antenna elements that are turned on, the more power and gain the antenna array has while having a narrower beamwidth. If a wider, lower gain beam is desired, less antenna elements may be turned on. This may be useful because a wide beam may be initially used, and once a signal is found (e.g., the antenna array is aligned with a satellite or other transceiver, etc.), the beam can be narrowed. These techniques also enable the antenna array to functionally include a sparse array, where some of the antenna elements may be turned off. The sparse array enables the gain to be lowered and the power to the antenna to be lowered while keeping a narrow beamwidth. The techniques described herein may also improve calibration of the antenna array, because calibration may be performed one beamforming circuit at a time.

This description provides examples, and is not intended to limit the scope, applicability or configuration of embodiments of the principles described herein. Rather, the ensuing description will provide those skilled in the art with an enabling description for implementing embodiments of the principles described herein. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

Example aspects of the disclosure are described in the context of devices and antenna subsystems. Aspects of the disclosure are further illustrated by and described with reference to apparatus diagrams, system diagrams, and flowcharts that relate to biasing radio frequency circuits with digital controls.

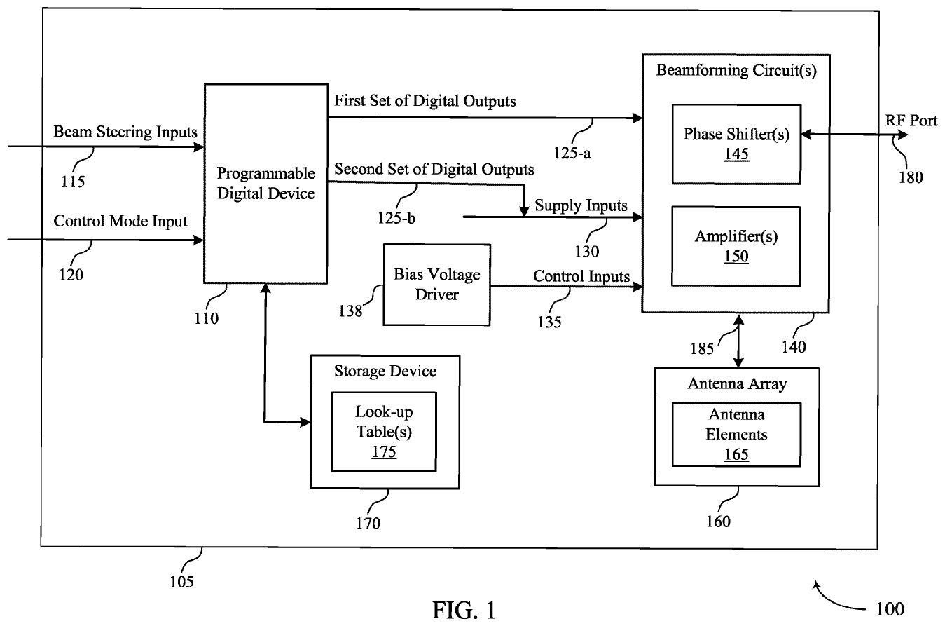

FIG. 1 illustrates an example of an antenna subsystem 100 that supports biasing radio frequency circuits with digital controls in accordance with aspects of the present disclosure. The antenna subsystem 100 may include a beamsteering board 105, a programmable digital device 110, one or more beamforming circuits 140, an antenna array 160, and a storage device 170. The antenna subsystem 100 may comprise a printed wiring assembly (PWA) or a printed wiring board (PWB).

The beamsteering board 105 may be a small form factor circuit board with digital circuit components mounted on it that provide the digital control and DC biases for the antenna array 160. The beamsteering board 105 may have one or more beamforming circuits 140 and the programmable digital device 110. For example, the first side (e.g., a front side) of the beamsteering board 105 may include the beamforming circuits. The beamsteering board may be connected with the antenna array 160. The second side (e.g., a back side) of the beamsteering board 105 may include the programmable digital device 110 and other digital or analog components such as storage device 170. In some examples, the beamsteering board 105 may include a control PWA and an RF board substrate. For example, the device 100 may include the beamsteering board 105 and an antenna board comprising the antenna array 160. The antenna array 160 may be mounted on the antenna board, which may be an RF board substrate. For example, the beamsteering board 105 may comprise a digital PWA on a first side with various connections that go to the components on the second side. The second side of the beamsteering board 105 may include beamforming circuits 140 and/or other circuits (e.g., analog or RF circuits).

The beamsteering board 105 may have very small form factor and be appropriate for space applications. In some examples, the beamsteering board 105 satisfies SWAP requirements for its particular application. In some examples, the beamsteering board 105 may have no spare area or very little spare area for additional components other than the programmable digital device 110, storage device 170, beamforming circuits 140, and various discrete components (e.g., resistors, capacitors) that are ancillary to these components.

The programmable digital device 110 may be any type of programmable digital device, such as a field programmable gate array (FPGA), a complex programmable logic device (CPLD), a programmable array logic (PAL), or an application specific integrated circuit (ASIC), for example. The programmable digital device 110 may be configured to output digital signals (e.g., “1”s and “0”s) via digital outputs 125. For example, the programmable digital device 110 may have a quantity of digital outputs 125, which may have a digital state configured via programmable circuits of the programmable digital device 110. The digital outputs 125 may be FPGA I/Os. The digital state may be driven by an I/O driver, which may be a complementary metal-oxide semiconductor (CMOS) driver. In some examples, the programmable digital device 110 may be a monolithic integrated circuit (e.g., may be fabricated on a single semiconductor substrate).

The digital outputs 125 may be generally compatible with transistor-transistor logic (TTL) levels, low voltage TTL (LVTTL) or low voltage CMOS (LVCMOS) voltage levels, for example having an I/O voltage supply (e.g., VDD, VDDIO, VDDQ, VCC, VCCIO, VCCQ) of 1.0V, 1.2V, 1.5V, 1.8V, 2.5V, 3.3V, or 5V. Each digital output 125 may be configured to output a low state (e.g., “0”) where the digital output 125 is coupled to a first supply rail (e.g., VSS or 0V) via a pull-down transistor and a high state (e.g., “1”) where the digital output 125 is coupled to a second supply rail (e.g., the I/O voltage supply) via a pull-up transistor. In some examples, at least some of the digital outputs 125 may be programmable impedance output drivers. For example, the drive strength for the digital outputs 125 may be adjustable (e.g., via a configuration of the programmable digital device 110). In some examples, a drive strength of the digital outputs 125 may be adjustable between several different drive strength values, which may be associated with supplying different amounts of current when outputting the high state. In some examples, the digital outputs 125 may be connected in parallel to increase the drive strength. For example, four digital outputs 125 may be connected together and each digital output 125 may have a drive strength of 6 milliamps (mA). If one of the digital outputs 125 are driving and the other three are disabled (e.g., tri-stated), then the drive strength would be 6 mA. If three are set to drive and one is disabled, then the drive strength would be 18 mA. If all four digital outputs 125 are driving, the drive strength would be 24 mA. In other examples, other drive strengths may be used.

The programmable digital device 110 may parse out data and provide drain bias voltages to the supply inputs 130 of the beamforming circuits 140. In some examples, a supply input may be referred to as a drain voltage, drain bias, or just bias. In some examples, the programmable digital device 110 may compute beamweights for the beamforming circuits 140 in firmware or software. In some examples, the beamforming circuits 140 may also have gate voltages that may set a gain of one or more amplifiers 150, which may be set to a fixed voltage and may the same for each beamforming circuit 140.

The programmable digital device 110 may receive inputs and provide digital outputs 125. For example, the programmable digital device 110 may receive beam steering inputs 115 and a control mode input 120. The beam steering inputs 115 may provide information related to beam steering for the antenna array. For example, the beam steering inputs 115 may provide a beam direction value to the programmable digital device 110, which may indicate a direction to steer the antenna array 160 (e.g., to beamform one or more beams transmitted by the antenna array 160 or to combine received signals of the antenna elements to form a receive beam). The beam steering inputs 115 may be a channel with one or more pins for communication of the beam direction value, which may be transferred over the channel serially or in parallel.

The control mode input 120 may provide the programmable digital device 110 with a control mode value related to the antenna array 160. The control mode input 120 may include a control mode value that identifies a control mode to the programmable digital device 110. The control mode may be a mode related to the antenna array 160. For example, the control mode may indicate a subset of the antenna elements 165 to have powered on. The programmable digital device 110 may use the control mode to control the supply inputs 130 for the one or more beamforming circuits 140. In some examples, the beam steering inputs 115 may be computed by another digital device, such as a micro-controller. In some examples, the programmable digital device 110 may consult one or more look-up tables 175 stored in the storage device 170 to determine the values of digital outputs 125 to control the supply inputs 130 based on the control mode from the control mode input 120. In other examples, the programmable digital device 110 stores the one or more look-up tables 175 itself, or computes the digital outputs 125. The look-up tables 175 may provide for multiple power configurations. Using the look-up tables 175, the programmable digital device 110 may receive a control mode and output the correct digital signals used to control drain current in the beamforming circuits 140 to achieve the power configuration associated with the control mode.

In some examples, the digital outputs 125 of programmable digital device 110 may directly supply power (e.g., supply current at or near the I/O supply voltage) to the beamforming circuits 140. In some examples, the programmable digital device 110 may do some baseband processing and output a baseband signal for upconverting. For example, the programmable digital device 110 may act as a modem or be part of a modem. In some cases, the programmable digital device 110 may perform baseband processing for the modem such as modulation, demodulation, encoding, decoding, and/or filtering of signals, such as baseband signals.

In some examples, the programmable digital device 110 controls beamsteering functions and the power to the beamforming circuits 140, which may perform beamsteering for the antenna array 160. That is, the same device controls beamsteering and also directly switches portions of the antenna array 160 on and off.

In an example, the programmable digital device 110 may include a single digital controller for the antenna array 160 where a portion (e.g., half or some part) of the antenna elements 165 is configured for transmission while another portion (e.g., the other half or another part) is configured for reception. The antenna array 160 may switched between a transmission mode or a reception mode as in a half-duplex system by turning on the antenna elements 165 configured for transmission or the antenna elements 165 configured for reception. In another example, half of the antenna array 160 may have antenna elements 165 associated with one polarization and the other half have antenna elements 165 associated with the opposite polarization (such as right hand and left-hand circular polarization or vertical and horizontal polarization). In this example, switching polarizations may be accomplished by turning on different parts of the antenna array 160. In another example, some of the antenna elements 165 may be tuned to different frequencies (e.g., a first portion of the antenna elements 165 may be tuned to a first frequency range while a second portion of the antenna elements 165 are tuned to second frequency range). Different frequencies may be supported by turning on or off different portions of the corresponding beamforming circuits 140.

The programmable digital device 110 may include one or more sets of digital outputs 125. As shown in FIG. 1, the programmable digital device 110 includes a first set of digital outputs 125-a and a second set of digital outputs 125-b (collectively referred to as digital outputs 125). The first set of digital outputs may be configured to provide phase adjustment control signals to the one or more phase shifters 145 or amplitude adjustment values to the one or more amplifiers 150 of at least a subset of the one or more beamforming circuits 140 based at least in part on a beam direction value. The beam direction value may come from or be determined from the beam steering inputs 115. The second set of digital outputs 125-b may be configured to directly power the supply inputs 130 of at least a subset of the one or more beamforming circuits 140 based at least in part on the control mode value. In some examples, the second set of digital outputs 125-b may directly power the supply inputs 130 because there may be no intervening components between the second set of digital outputs 125-b and the supply inputs 130. Additionally or alternatively, the second set of digital outputs 125-b may directly power the supply inputs 130 because current flowing into the supply inputs 130 is received directly from the second set of digital outputs 125-b (e.g.,. the second set of digital outputs 125-b supply current for powering the supply inputs 130).

The control mode value provides an index to control the supply inputs to the beamforming circuits 140. The programmable digital device 110 may set the first set of digital outputs 125-a based on the index value of the control mode value. In some examples, a subset of the first set of the plurality of digital outputs may be directly coupled to the one or more phase shifters of at least one beamforming circuit 140.

The programmable digital device 110 may control whether individual beamforming circuits 140 are on or off, which provides an adjustable beam pattern and power output of the antenna array 160. The programmable digital device 110 may control the one or more beamforming circuits 140 using direct current (DC) bias via the digital outputs 125. In some examples, at least a subset of the digital outputs 125 may be configured to be selectively turned on or off in order to selectively enable subsets of beamforming circuits 140. For example, digital output states of a first subset of the digital outputs 125 may be set to a high digital output state to enable (e.g., power on) a first subset of the beamforming circuits 140 while digital output states of a second subset of the digital outputs 125 may be set to a low digital output state to disable (e.g., power off) a second subset of the beamforming circuits 140. In some examples, a power state of at least one of two or more of the second set of digital outputs 125 may be adjusted to change an amplitude associated with an amplifier (150) of the plurality of beamforming circuits (140). For example, one or more of the second set of digital outputs 125 may include a programmable impedance output driver, and may be adjusted to one of a plurality of power states that provide different levels of current to corresponding beamforming circuits 140. In some examples, at least a first subset of the second set of digital outputs 125-a connected to at least a first set of the plurality of beamforming circuits 140 may be set to an off state.

In some cases, a group of digital outputs 125 may be coupled in parallel to a same beamforming circuit 140. In some cases, a subset of the group of digital outputs may be set to the high digital output state to adjust an amplitude of an amplifier of the beamforming circuit 140 connected to the group of digital outputs 125, while the rest of the group of digital outputs 125 may be set to a high-impedance state (e.g., tri-stated). For example, where each digital output 125 may source a given amount of current, the current through the amplifier 150 of a beamsteering circuit may be set to one of multiple levels by selectively driving subsets of the digital outputs 125.

The one or more beamforming circuits 140 may be custom integrated circuit units (ICUs) that control the phase, amplitude, or both going to some or all of the plurality of antenna elements 165. The one or more beamforming circuits 140 may be small RF components that can control the phase and/or the amplitude of component RF signals 185 communicated with one or more antenna elements 165 of the antenna array 160. The one or more beamforming circuits 140 may communicate component RF signals 185 with the antenna array 160. The component RF signals 185 may be output from the one or more beamforming circuits 140 to the antenna array 160 for transmission or input at the one or more beamforming circuits 140 as received signals at the antenna array 160. In some examples, the one or more beamforming circuits 140 are monolithic integrated circuits, microchips, silicon chips, Gallium Arsenide (GaAs) chips, Indium Phosphide (InP) chips, Gallium Nitride chips, III-V chips, or other chips. In some examples, the one or more beamforming circuits 140 are MMICs. The one or more beamforming circuits 140 may be located on either side of the beamsteering board 105. In some examples, two beamforming circuits 140 may be affixed to two separate circuit boards, and the circuit boards may be attached together.

The one or more beamforming circuits 140 may include one or more phase shifters 145. In some cases the one or more beamforming circuits 140 may include the one or more amplifiers 150. The one or more amplifiers 150 may be power amplifiers, low noise amplifiers, or both. In some examples, the one or more amplifiers 150 may be or include field-effect transistors (FETs), bipolar junction transistors (BJTs), heterojunction bipolar transistor (HBTs), or other types of transistors. In some cases, the first set of digital outputs 125-a provide phase adjustment control signals to the beamforming circuits 140 to adjust the relative phase offsets of the beamforming circuits 140. In some examples, the phase shifters 145 may each have one or more input signals or channels, including an input channel for the phase adjustment control signal (e.g., which may be received in serial or parallel), the supply input (which may provide power to the phase shifter 145), or a radio frequency port 180. The programmable digital device 110 may receive the beam angle value as part of the beam steering inputs 115. The programmable digital device 110 may convert the beam angle value into the first set of digital outputs 125-a, which may be the phase adjustment control signals for the phase shifters. For example, the phase adjustment control signals may be part of the first set of digital outputs 125-a.

In some examples, the amplifiers 150 may include a supply input (which may provide power to the amplifier 150), and a control input 135 (which may provide control for the amplification). The control inputs 135 may set various bias voltages in the amplifiers 150. For example, the control inputs 135 may set gate bias voltages, and may be high impedance inputs (e.g., may not draw significant steady-state current). The control inputs 135 may be tied to a common signal (e.g., reference voltage) from a bias voltage driver 138. Thus, the bias voltages or currents in the amplifiers 150 may be set to common values.

Each of the one or more beamforming circuits 140 may be connected to one or more antenna elements 165. For example, a beamforming circuit 140 may be connected to two antenna elements 165, three antenna elements 165, four antenna elements 165, or other quantities of antenna elements 165. In other examples, each beamforming circuit 140 may be connected to only one antenna element 165. The digital outputs 125 may control the operations of the one or more beamforming circuits 140. The one or more beamforming circuits 140 may have a phase shifter 145 and an amplifier for each antenna element 165.

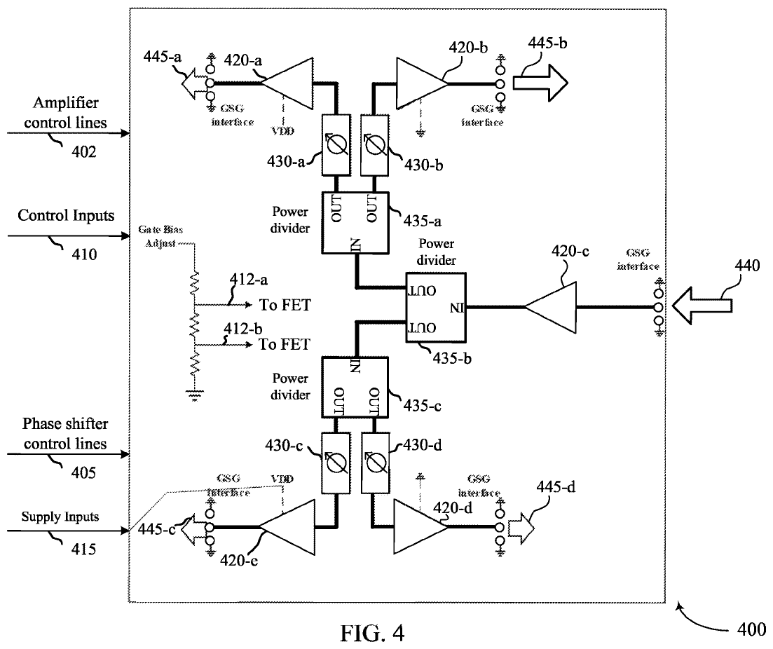

In some examples, the one or more beamforming circuits 140 may be monolithic integrated circuits, such as MMICs. The one or more beamforming circuits 140 may draw less than 5 mW of power, less than 10 mW of power, or less than 15 mW of power. In some cases, the beamforming circuits 140 draw less power than a drive strength of the digital outputs 125 of programmable digital device 110 (e.g., of one digital I/O pin of an FPGA). In some examples, the beamforming circuits 140 draw less power than two or three times the drive strength of the programmable digital device 110. The drive strength of the digital outputs 125 of programmable digital device 110 may be given by an amount of current the digital output 125 can supply without the output voltage going below a threshold, such as 90%, 95%, or some other percentage of the I/O voltage supply level. Techniques described herein provide for a very compact device while being able to control the one or more beamforming circuits 140 (being able to turn some on and others off) via unique supply inputs 130 to each one or more beamforming circuits 140. For example, all of the beamforming circuits 140 may be enabled (e.g., turned on) or disabled (e.g., turned off). The amplifiers 150 may be turned on or off by controlling the supply inputs 130. In addition, the amplification of the amplifiers 150 may be controlled via the control inputs 135, which may set gate voltages provided to one or more transistors (e.g., control inputs 410 described in FIG. 4). However, in some cases the control inputs 135 of beamforming circuits 140 may be kept at a fixed bias voltage (e.g., all of the control inputs 135 may be tied to a common reference voltage to maintain a common amplification from the amplifiers 150) while the first set of digital outputs 125-a may be turned on or off to enable or disable the beamforming circuits 140. For example, the I/O supply voltage of the programmable digital device 110 may be supplied to the beamforming circuits when they are powered on and 0 V may be supplied to turn them off. Some examples may include setting the digital output values for the second set of digital outputs 125 to one or more logic states, which may correspond to one or power states (e.g., an off power state or an on power state). For example, a first subset of the second set of digital outputs 125 may be set to a first logic state (e.g., on state) to enable a first subset of the plurality of beamforming circuits 140 and a second subset of the second set of digital outputs 125 may be set to a second logic state (e.g., off state) to disable a second subset of the plurality of beamforming circuits 140. An enabled beamforming circuit may receive power from a digital output 125 sufficient to turn on the beamforming circuit to perform amplification of one or more input RF signals to output one or more RF signals (e.g., according to one or more programmed phase values). The first logic state may correspond to a first voltage level and the second logic state may correspond to a second voltage level different from the first voltage level.

The antenna array 160 may be mounted directly on the beamsteering board 105 or on an RF board substrate coupled with (e.g., via one or more connectors) the beamsteering board 105. The antenna array 160 and beamforming circuits 140 may be an electronically steerable array (ESA). The beamforming circuits 140 may receive beamforming data (e.g., beamweights) and one or more sets of digital outputs (e.g., drain voltage outputs), which may be used to steer the antenna array 160. In some examples, the antenna array 160 may include a plurality of antenna elements 165. In some examples, the number of antenna elements 165 may be greater than 100 or greater than 1000. Each of the antenna elements 165 may be, for example, a dipole antenna, a microstrip antenna, a patch antenna, a horn antenna, or other type of antenna element. In some examples, multiple antenna arrays 160 and associated beamforming circuits 140 may be used together to form a larger array. In such an example, each sub-array of the larger array may be controlled with a separate controller.

In some examples, the storage device 170 may not be a separate device, but may be incorporated into another device on the beamsteering board 105. For example, the storage device 170 may be part of the programmable digital device 110.

In some examples, the antenna subsystem 100 may be an ultra-low power device with a very small form factor. The antenna subsystem 100 may be used in applications, such as, for example, communications, radar, or ranging applications.

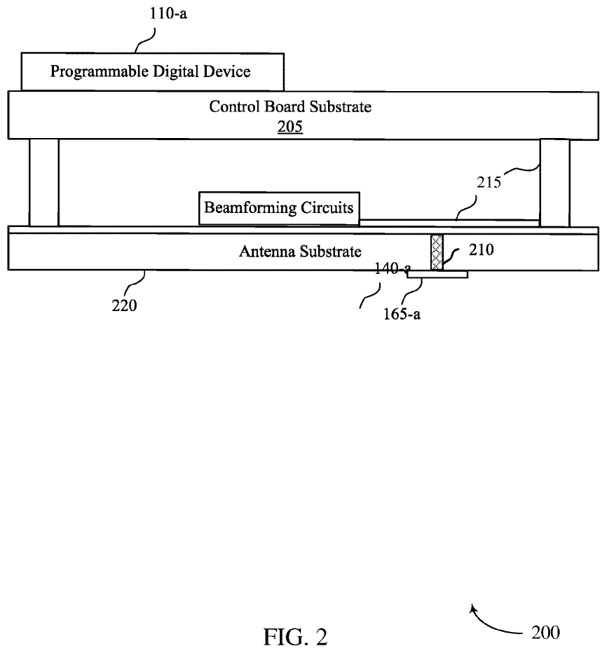

FIG. 2 illustrates a side view of an example of a device 200 that supports biasing radio frequency circuits with digital controls in accordance with aspects of the present disclosure. The device 200 may be an example of aspects of a radio frequency circuit as described herein. The device 200 may include a control board substrate 205, a programmable digital device 110-a, one or more beamforming circuits 140-a, an antenna substrate 220, and one or more antenna elements 165-a. Each of these components may be in communication with one or more other components (e.g., via one or more vias 210, signal traces, channels, or buses). The programmable digital device 110-a, the beamforming circuits 140-a, and the one or more antenna elements 165-a may be examples of one or more aspects of the beamsteering board 105, the programmable digital device 110, the beamforming circuits 140, and the one or more antenna elements 165-a as described in FIG. 1. In some examples, the control board substrate 205 may also include or be coupled with an antenna substrate 220 (e.g., a beamsteering board). The device 200 may also include a plurality of direct current (DC) connections 215 (e.g., inputs and outputs) among the components of the device 200 and any other additional circuitry.

The device 200 may include one or more beamforming circuits 140-a on a first side of the antenna substrate 220. The device 200 may include one or more antenna elements 165-a on a second side of the antenna substrate 220. The device 200 shows the programmable digital device 110-a on a first side of the control board substrate 205. In other examples, other configurations of the components may be used, such as having the beamforming circuits 140-a on a second side of the control board substrate 205 and having a separate RF board for the one or more antenna elements 165-a. In some examples, the control board substrate 205 may be a circuit board, wherein the plurality of beamforming circuits 140-a are located on a first side of the circuit board and the programmable digital device 110-a is located on a second side of the control board substrate 205 opposite to the first side.

The one or more antenna elements 165-a may be mounted on or otherwise affixed to the antenna substrate 220. A plurality of vias 210 may be present in the antenna substrate 220 to provide electrical connection between the one or more antenna elements 165-a and the beamforming circuits 140-a. In some examples, there may be a via 210 for each antenna element 165-a. In some examples, the antenna substrate 220 may be located on a second side of the control board substrate 205. The beamforming circuits 140-a may also be mounted on or otherwise affixed to the antenna substrate 220. In some examples, the beamforming circuits 140-a are mounted on a side of the antenna substrate 220 opposite from a side on which the antenna elements 165-a are mounted.

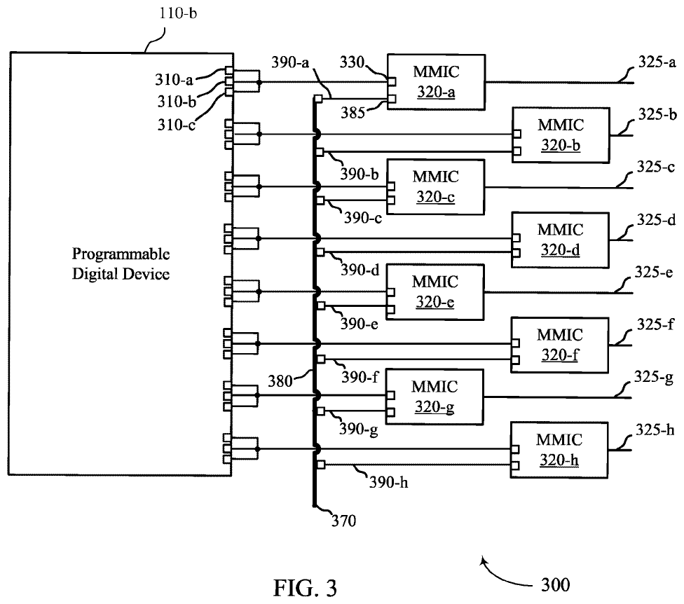

FIG. 3 illustrates an example of a device 300 that supports biasing radio frequency circuits with digital controls in accordance with aspects of the present disclosure. The device 300 may be an example of aspects of a radio frequency circuit as described herein. The device 300 may include programmable digital device 305 (e.g., an FPGA, a CPLD, an ASIC, etc.) and a plurality of MMICs 320-a through 320-h (referred to collectively herein as MMICs 320). Each of the MMICs 320 may include a supply input 330 and an RF input 385 (only one of each of which are labeled for clarity). The device 300 may include an RF beamforming network 380, which may include one or more RF combiner/dividers (e.g., splitters). For example, the RF beamforming network 380 may include multiple RF combiner/dividers with equalized signal traces such that there may be equal delay between an RF common port 370 and each individual RF signal 390 that goes to MMICs 320. The MMICs 320 may each have the RF input 385 coupled with one of the individual RF signals 390 from the RF beamforming network 380. RF common port 370 may be coupled with RF circuitry (e.g., amplifiers, mixers) that generates or receives an RF signal.

Each MMIC 320 may have an input/output for a component RF signal 325 (e.g., component RF signals 325-a through 325-h), which may be coupled with respective antenna elements of an antenna array such as antenna elements 165 of antenna array 160 of FIG. 1. The programmable digital device 305 may be an example of one or more aspects of a programmable digital device 110 described with respect to FIGS. 1 and 2. The MMICs 320 may be an example of one or more aspects of the one or more beamforming circuits 140 described with respect to FIGS. 1 and 2.

In some cases, each MMIC 320 may use a greater amount of current than can be supplied using a single output 310 of the programmable digital device 305. In the example of FIG. 3, two or more outputs 310 of the programmable digital device 305 are connected together to provide an input to a single MMIC 320. For example, three outputs 310-a, 310-b, and 310-c may be tied together to one signal which is coupled with the supply input 330 of MMIC 320-a. These outputs 310-a, 310-b, and 310-c may be tied together in order to source enough current to supply the MMIC 320-a. In some cases, each of the outputs 310 may have the same drive strength, and thus the current that may be supplied from programmable digital device 110-b to a MMIC 320 may be determined by the quantity of outputs 310 that are coupled with the supply input 330 of the MMIC and how many are turned on. In some cases, multiple outputs 310 may be tied together that have different drive strengths. For example, if output 310-a can supply 5 mA, and outputs 310-b and 310-c can supply 2.5 mA, a total supply current to a MMIC 320 may be adjusted to be 2.5 mA, 5 mA, 7.5 mA, or 10 mA by enabling different combinations of outputs 310 coupled with the MMIC 320. In other examples, other numbers of outputs 310 may be tied together to supply a MMIC 320. Because the supply input 330 of the MMICs 320 may provide power to the amplifier circuits (e.g., drain current for the amplifier circuits) or phase shifter circuits of the MMICs 320, all or substantially all of the power going into each MMIC 320 may come from the programmable digital device 305.

By powering off at least some of the digital outputs connected to the beamforming circuits, the bias of the circuit may be changed due to the inability of the remaining circuits to provide the full current. This may taper the resulting antenna beam and provide lower sidelobes of the antenna beam. For example, in FIG. 3, a group of outputs 310 (e.g., the outputs 310-a, 310-b, and 310-c) may all be connected to a single supply input 330, so that the programmable digital device 305 can source enough current for operation at a full power for the MMIC 320. If outputs 310-b and 310-c are turned off, for example, but output 310-a is turned on, the programmable digital device 305 may be current starved, thereby lowering the output power on some devices. This could be selectively done to certain antenna elements in order to taper the amplitude across the antenna array, thereby reducing any sidelobes of the antenna array.

The outputs 310 may be digital outputs, which may be switched between states of a logic “1,” a logic “0,” or a tri-state (high impedance, drive outputs disabled). A logic “1” turns a MMIC 320 on, by changing the voltage on the supply input to a high value (e.g., the I/O supply voltage of the programmable digital device 110-b) and sourcing current. A logic “0” turns the MMIC 320 off by turning the drain voltage to a low value (e.g., 0 V). In some cases, a tri-state may also turn off a MMIC 320, as no current may be supplied by the digital output. No power switches are needed as the digital outputs 310 directly drive the supply inputs of the MMICs 320.

FIG. 4 illustrates an example of a MMIC 400 that supports biasing radio frequency circuits with digital controls in accordance with aspects of the present disclosure. The MMIC 400 may be an example of aspects of a MMIC 320 as described herein with respect to FIG. 3. The illustrated MMIC 400 may be one or more MMICs of a beamforming circuit, such as the beamforming circuit 140. The MMIC 400 receives inputs and provides outputs that can be used to control one or more antenna elements of an antenna array, such as the antenna elements 165 of antenna array 160.

The MMIC 400 may receive one or more phase shifter control lines 405 as input to a phase shifter 430-a. In some examples, there may be twelve phase shifter control lines 405. In other examples, there may be other numbers of phase shifter control lines 405. The MMIC 400 may receive one or more amplifier control lines 402. The amplifier control lines 402 and phase shifter control lines 405 may be coupled with the first set of digital outputs 125-a of FIG. 1. The one or more phase shifter control lines 405 may provide phase control from a programmable digital device, such as the programmable digital device 110 described herein. In some examples MMIC 400 may receive values for amplifier control lines 402 and phase shifter control lines 405 (e.g., via digital outputs 125-a), and may store the values of amplifier control lines 402 and phase shifter control lines 405 in registers. For example, each MMIC 400 may be separately addressed via digital outputs 125-a, shown in FIG. 1, and may store the values for amplifier control lines 402 and phase shifter control lines 405. In some cases, the amplifier control lines 402 and the phase shifter control lines 405 may be combined into a single set of control lines.

The MMIC 400 may also receive control inputs 410 as an input that biased a gate of one or more FETs, or other transistors (e.g., of amplifiers 420). In some examples, there may be one to six control inputs 410. In some examples, the control inputs 410 may be the control inputs 135 of FIG. 1. The control inputs 410 may be a reference voltage created from a voltage divider circuit or other traditional analog biasing scheme. The control inputs 410 may be used to generate one or more gate bias voltages such as FET gate bias 412-a and FET gate bias 412-b. In some cases, FET gate bias 412-a and FET gate bias 412-b may control (e.g., via gates of current source transistors) bias currents in amplifiers 420.

The MMIC 400 may also receive supply inputs 415. The supply inputs 415 may supply drain currents that directly provide the current for components the MMIC 400 (e.g., phase shifters 430, amplifiers 420, etc.). In some examples, each MMIC 400 may receive three supply inputs 415. In some examples, there may be one to six supply inputs 415, or another number of supply inputs 415.

When operating the device (such as device 300 of FIG. 3) in some instances, control of current supplied to supply inputs 415 may adjust output power on MMIC 400. For example, the MMIC 400 may draw a first current at a first voltage via supply inputs 415 and a second, lower current at a second, lower voltage. Thus, the power output of MMIC 400 may be controlled by reducing the current drive to supply inputs 415. This functionality may provide a tapering ability which enables the beam generated at the antenna array to be shaped. For example, in order to get low sidelobes, the amplitudes may be tapered such that the antenna elements on the edge of the antenna array transmit less power.

In another example, supply inputs 415 for different MMICs 400 may be coupled to different digital outputs 125-b that supply different currents (or different impedances, for example). For example, the supply inputs 415 may be connected to pins on a programmable digital device, such as the programmable digital device 110, that are programmed for different voltages or different current handling capabilities. In one example, the supply inputs 415 for a first MMIC may be connected to a 1.5 V digital output driver, the supply inputs 415 for a second MMIC may be connected to a 1.2 V/5 mA line, and the supply inputs 415 for a third MMIC may be connected to a 1.2 V/1 mA output. By switching which output is powered on, different voltage or current ability may be provided to different MMICs. This may cause different operating conditions, allowing the beam to be tapered or allowing the device to operate in a different state. In addition to beam tapering, this could just be for overall output power control and the like.

The control inputs 410 and the supply inputs 415 may be fixed voltages. The gate, drain, and phase shifter connections shown in the MMIC 400 are just one example configuration, and other configurations may be used. There may be multiple gate, drain, and phase shifter connections in a MMIC 400.

The MMIC 400 may also receive RF inputs 440. The RF input 440 may be coupled with an RF signal, which may come from RF circuitry (e.g., amplifiers, mixers, etc.) that generates the RF signal from a baseband signal.

The MMIC 400 may include a plurality of power dividers 435 (e.g., power dividers 435-a, 435-b, and 435-c), a plurality of amplifiers 420 (e.g., amplifiers 420-a, 420-b, 420-c, 420-d, and 420-e), and a plurality of phase shifters 430 (e.g., phase shifters 430-a, 430-b, 430-c and 430-d). In some examples, the current supplied via supply inputs 415 may flow through gain transistors of the amplifiers 420.

In some examples, the MMIC 400 may drive up to four antenna elements using RF outputs 445 using two stages of power dividers 435. For example, RF output 445-a may drive a first antenna element, RF output 445-b may drive a second antenna element, RF output 445-c may drive a third antenna element, and RF output 445-d may drive a fourth antenna element. However, in other examples, a MMIC 400 may drive just one antenna element, two antenna elements, or other number of antenna elements. For example, a MMIC 400 may have a single stage and may drive one (without a power divider 435), or two (e.g., with a single power divider 435). Alternatively, MMIC 400 may have more than two stages of power dividers 435. For example, a MMIC 400 may have three stages of power dividers 435, and may drive eight RF outputs 445. Although MMIC 400 is illustrated as used in an RF output configuration, it should be understood that MMIC 400 may support receiving RF signals. For example, a MMIC 400 may have additional amplifiers 420 and combiners to combine multiple RF component signals received via multiple antenna elements. In some cases, a MMIC 400 may be configured to transmit and/or receive via a same set of antenna elements (e.g., using different frequencies, different polarizations, or different time periods, etc.).

It should be noted that, in addition to the transmit path of the MMIC 400 shown in FIG. 4, MMIC 400 may have a receive path. For example, the receive path may include a plurality of amplifiers coupled with RF inputs, which may be low noise or low power amplifiers and may be different from the power amplifiers of the transmit path. The receive path may also include phase shifters similar to phase shifters 430 of the transmit path. The receive path may include power combiners, which may be similar to the power dividers 435 (e.g., though having two input ports and one output port). In some cases, the receive path may have separate amplifier control lines 402, control inputs 410, phase shifter control lines 405, or supply inputs 415. For example, the amplifiers of the receive path may be coupled with (e.g., drain current supplied by) a first supply input 415, while the amplifiers of the transmit path may be coupled with (e.g., drain current supplied by) a second supply input 415. In some cases, the amplifiers of the transmit path may be coupled with more supply inputs 415 than the amplifiers of the receive path. For example, the amplifiers of the receive path may be low noise amplifiers and may have relatively lower drain current than the power amplifiers 420 of the transmit path. Thus, multiple digital outputs of the programmable digital device 110 may be used to supply drain current to the power amplifiers 420 of the transmit path while a single digital output of the programmable digital device 110 may be used to supply drain current to the amplifiers of the receive path. In addition, having multiple digital outputs of the programmable digital device 110 being used to supply drain current to the power amplifiers 420 of the transmit path may allow for control of the drain current of the power amplifiers 420 of the transmit path separately from the drain current of the amplifiers of the receive path. Thus, in some cases a power amplifier 420 of a transmit path of a MMIC 400 may be driven using a lower current setting (e.g., a lower percentage of full current), while the amplifiers of the receive path are driven at the full current via the separate supply input 415.

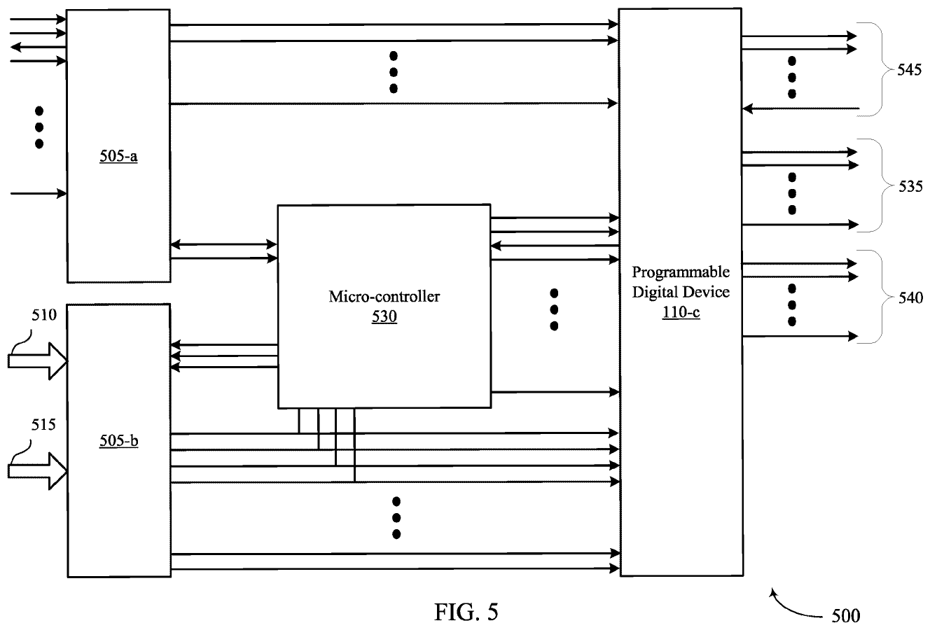

FIG. 5 illustrates an example circuit diagram for a device 500 that supports biasing radio frequency circuits with digital controls in accordance with aspects of the present disclosure. The device 500 may be an example of aspects of a radio frequency circuit as described herein. The device 500 may include connectors 505-a and 505-b, a micro-controller 530, and a programmable digital device 110-c. Each of these components may be in communication with one or more other components. The programmable digital device 110-c may be an example of one or more aspects of a programmable digital device 110 described with respect to FIG. 1, 2, or 3. The connectors 505 and the micro-controller 530 may be an example of one or more aspects of the circuitry of control board substrate 205 described with respect to FIG. 2. The connectors 505 may provide connections from other components (e.g., external to the device 500), and may include pins, slots, or tabs for connection via cables or other board-to-board connectors.

Control mode input 510 may provide a control mode value via connector 505-b. The control mode value (also referred to as an antenna mode) may determine the digital biases, which may determine which beamforming circuits may be on or off. The control mode value may take on different values associated with different configurations for the MMICs of device 500, for example, which can be programmable. For example, the control mode value may be set so that all of the MMICs are on, while in another example the control mode value may be such that some portion of the MMICs are on and another portion are off. Other examples may use other control mode values. The beam steering input 515 may provide a beam direction value, which may include one or more angular directions (e.g., elevation and azimuth angles) for the antenna array. The beam steering input 515 may be passed to the micro-controller 530, which may compute the beam weights for the antenna array based on the elevation and azimuth angles. The micro-controller 530 may use software to determine the beam weights based on the inputs it receives. The connectors 505 and the micro-controller 530 provide digital signals to the programmable digital device 110-c. In some examples, the beam steering input 515 may be used to form a beam at the antenna array exclusive of at least a portion of the antenna elements in the antenna array.

The programmable digital device 110-c may parse (e.g., split or decode a long serial digital stream into different signals for each beamforming circuit) the phase commands and translate the control mode value to determine the power state (e.g., on or off) for each MMIC. Programmable digital device 110-c may use a look-up table to determine the bias states, indexed according to the control mode value. The programmable digital device 110-c may provide supply inputs of beamforming circuits of an ESA directly from digital outputs 535. In some cases, programmable digital device 110-c may have one digital output 535 for each beamforming circuit, or may have multiple digital outputs 535 for each beamforming circuit (e.g., with multiple digital outputs tied together to supply current for one beamforming circuit). If the antenna array includes 100 antenna elements, for example, programmable digital device 110-c may have one hundred (100) or more than one hundred (100) digital outputs 535. The programmable digital device 110-c may also output beamforming data (e.g., beamweights) to the beamforming circuits via digital signals 555. The beamweights may be output to the beamforming circuits serially. For example, digital signals 555 may be a serial bus coupled with each beamforming circuit, where each beamforming circuit is associated with an address and can be addressed individually via the serial bus to transfer the beamweights. In other examples, other configurations are contemplated.

The level of biasing may be varied by how many outputs of the programmable digital device 110-c are tied together. For example, one set of outputs could be tri-stated and other outputs could be used as a single output. That technique could be used to effectively lower the voltage based on the drive strength of the programmable digital device 110-c. The programmable digital device 110-c may try to supply enough current to the MMIC to meet the gate conditions of the MMIC. However, if the MMIC begins to exceed the amount of current programmable digital device 110-c can supply via the active outputs connected to the MMIC, then the voltage may sag. This may change the gain at the MMIC, which may be used to control (e.g., reduce) the amplitude of signal output at the antenna array. This technique may be used to modulate the signal output at the antenna array, such as tapering the antenna array to reduce side lobes.

Programmable digital device 110-c may also include a second set of digital outputs 550 that may be coupled with control inputs of the beamforming circuits. Alternatively, the control inputs of the beamforming circuits may be driven by a common reference voltage (e.g., generated externally to programmable digital device 110-c).

The device 500 illustrates ultra-low power components with very small form factors. The digital outputs from the programmable digital device 110-c may provide drain bias voltages to turn beamforming circuits on and off, which may control one or more antenna elements of the antenna array 160. Because the amplifiers of the beamforming circuits are low power, one or more of the digital outputs of the programmable digital device 110 may be tied together to power the beamforming circuits. Techniques described herein use digital circuitry to provide biasing for beamforming circuits, such as MMICs, to enable full control over the beamforming circuits because there are hundreds of outputs available from the programmable digital device (e.g., an FPGA chip). The techniques described herein enable programming of which drain voltages are to be turned on and off, creating a lot of flexibility and control.

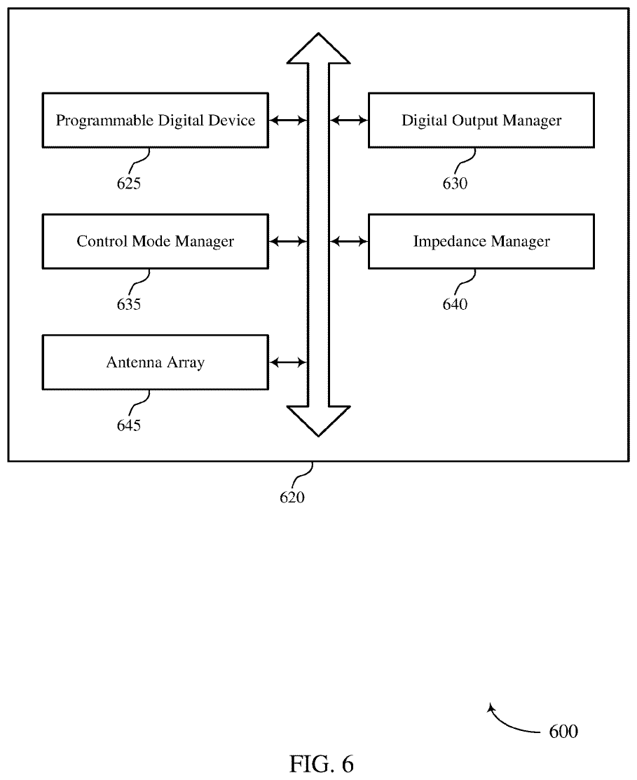

FIG. 6 shows a block diagram 600 of a device 620 that supports biasing radio frequency circuits with digital controls in accordance with aspects of the present disclosure. The device 620 may be an example of aspects of a device 100, 200, 300, or 500 as described herein. The device 620, or various components thereof, may be an example of means for performing various aspects of biasing radio frequency circuits with digital controls as described herein. For example, the device 620 may include a programmable digital device 625, a digital output manager 630, a control mode manager 635, an impedance manager 640, an antenna array 645, or any combination thereof. Each of these components may communicate, directly or indirectly, with one another (e.g., via one or more buses).

The programmable digital device 625 may be configured as or otherwise support a means for receiving, at the programmable digital device 625, a beam direction value for an antenna subsystem including a set of multiple beamforming circuits, where each beamforming circuit of the set of multiple beamforming circuits is configured to adjust component radio frequency signals for one or more antenna elements, and where each beamforming circuit of the set of multiple beamforming circuits includes one or more phase shifters, one or more amplifiers, and a supply input for providing supply power to the one or more amplifiers. The digital output manager 630 may be configured as or otherwise support a means for transmitting, by the programmable digital device based on the beam direction value, phase adjustment control signals to the one or more phase shifters of at least a subset of the set of multiple beamforming circuits via a first set of digital outputs of the programmable digital device. In some examples, the digital output manager 630 may be configured as or otherwise support a means for setting, by the programmable digital device 625, digital output values for a second set of digital outputs of the programmable digital device 625 to enable the at least the subset of the set of multiple beamforming circuits, the second set of digital outputs configured to directly power the supply inputs of the set of multiple beamforming circuits.

In some examples, the control mode manager 635 may be configured as or otherwise support a means for receiving, at the programmable digital device, a control mode value, where setting the digital output values for the second set of digital outputs is based on the control mode value.

In some examples, the control mode manager 635 may be configured as or otherwise support a means for applying, by the programmable digital device, the control mode value to a look-up-table to determine the digital output values for the second set of digital outputs, the look-up-table including a set of multiple sets of the digital output values for the second set of digital outputs.

In some examples, two or more of the second set of digital outputs are directly coupled to the supply input of a beamforming circuit of the set of multiple beamforming circuits.

In some examples, setting the digital output values for the second set of digital outputs includes setting a first subset of the second set of digital outputs to a first logic state to enable a first subset of the set of multiple beamforming circuits and setting a second subset of the second set of digital outputs to a second logic state to disable a second subset of the set of multiple beamforming circuits.

In some examples, the antenna array 645 may be configured as or otherwise support a means for communicating signals via a beam formed using a first portion of an antenna array based least in part on enabling the first subset of the set of multiple beamforming circuits, where the beam is formed exclusive of antenna elements of a second portion of the antenna array associated with the second subset of the set of multiple beamforming circuits. The beam being formed exclusive of antenna elements of the second portion of the antenna array may refer to forming the beam without using the antenna elements of the second portion of the antenna array. In some examples, the beam is formed using only a set or subset of the first portion of the antenna array. In some examples, enabling a subset of the plurality of beamforming circuits may include turning on, or changing a power state of, the subset of the plurality of beamforming circuits.

In some examples, each beamforming circuit of the set of multiple beamforming circuits includes a control input for setting an operating point of the beamforming circuit, and the digital output manager 630 may be configured as or otherwise support a means for setting, by the programmable digital device, digital output values.

In some examples, each of the second set of digital outputs of the programmable digital device includes a programmable impedance output driver, and the impedance manager 640 may be configured as or otherwise support a means for setting, by the programmable digital device, an impedance of each of the second set of digital outputs.

In some examples, each of the set of multiple beamforming circuits is a monolithic microwave integrated circuit. In some examples, the programmable digital device is a monolithic integrated circuit, a complex programmable logic device, or a field programmable gate array.

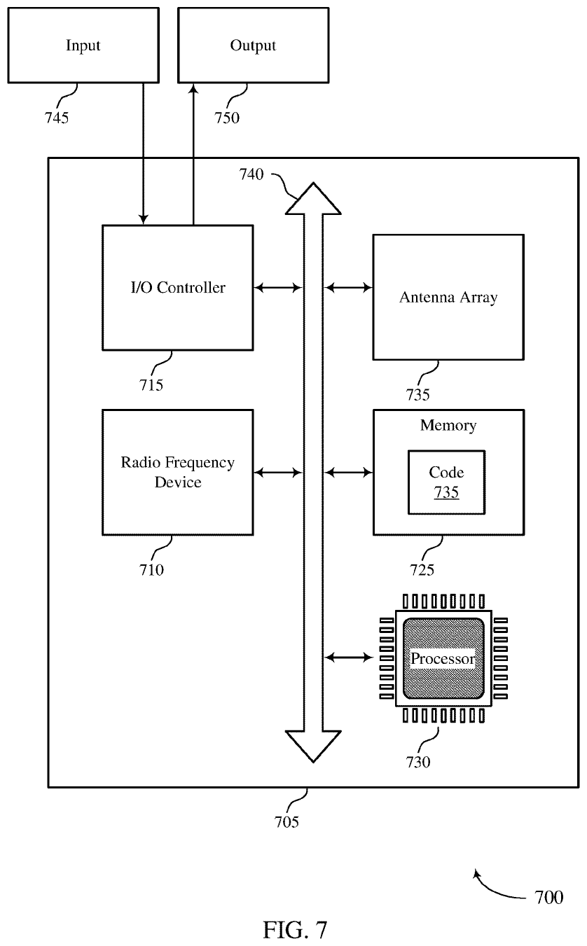

FIG. 7 shows a diagram of an antenna subsystem 700 including a device 705 that supports biasing radio frequency circuits with digital controls in accordance with aspects of the present disclosure. The device 705 may be an example of or include the components of a device 100, 200, 300, 400, or 620 as described herein. The antenna subsystem 700 may include components for biasing radio frequency circuits with digital controls, including a radio frequency device 710, an I/O controller 715, an antenna array 735, a memory 725, and a processor 730. These components may be in electronic communication via one or more buses (e.g., bus 740). The radio frequency device 710 may be an example of a device 500 or 620 as described herein.

The I/O controller 715 may manage input signals 745 and output signals 750 for the device 705. The I/O controller 715 may also manage peripherals not integrated into the device 705. In some cases, the I/O controller 715 may represent a physical connection or port to an external peripheral. 77 In some cases, the I/O controller 715 may be implemented as part of a processor. In some cases, a user may interact with the device 705 via the I/O controller 715 or via hardware components controlled by the I/O controller 715.

Memory 725 may include random-access memory (RAM) and read-only memory (ROM). The memory 725 may store computer-readable, computer-executable software including instructions that, when executed, cause the processor to perform various functions described herein. In some cases, the memory 725 may contain, among other things, a basic input/output system (BIOS) which may control basic hardware or software operation such as the interaction with peripheral components or devices. The memory 725 may include one or more look-up tables.

The processor 730 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions.

The RF device 710 may be configured as or otherwise support a means for receiving, at a programmable digital device, a beam direction value for an antenna subsystem including a set of multiple beamforming circuits, where each beamforming circuit of the set of multiple beamforming circuits is configured to adjust component radio frequency signals for one or more antenna elements, and where each beamforming circuit of the set of multiple beamforming circuits includes one or more phase shifters, one or more amplifiers, and a supply input for providing supply power to the one or more amplifiers. The communications manager 720 may be configured as or otherwise support a means for transmitting, by the programmable digital device based on the beam direction value, phase adjustment control signals to the one or more phase shifters of at least a subset of the set of multiple beamforming circuits via a first set of digital outputs of the programmable digital device. The communications manager 720 may be configured as or otherwise support a means for setting, by the programmable digital device, digital output values for a second set of digital outputs of the programmable digital device to enable the at least the subset of the set of multiple beamforming circuits, the second set of digital outputs configured to directly power the supply inputs of the set of multiple beamforming circuits. By including or configuring the RF device 710 in accordance with examples as described herein, the device 705 may support techniques for biasing radio frequency circuits with digital controls.

In some examples, the antenna array 735 may be configured to perform various operations (e.g., receiving, transmitting). Although the RF device 710 is illustrated as a separate component, in some examples, one or more functions described with reference to the RF device 710 may be supported by or performed by the processor 730, the memory 725, code 755, or any combination thereof. For example, the code 755 may include instructions executable by the processor 730 to cause the device 705 to perform various aspects of biasing radio frequency circuits with digital controls as described herein, or the processor 730 and the memory 725 may be otherwise configured to perform or support such operations.

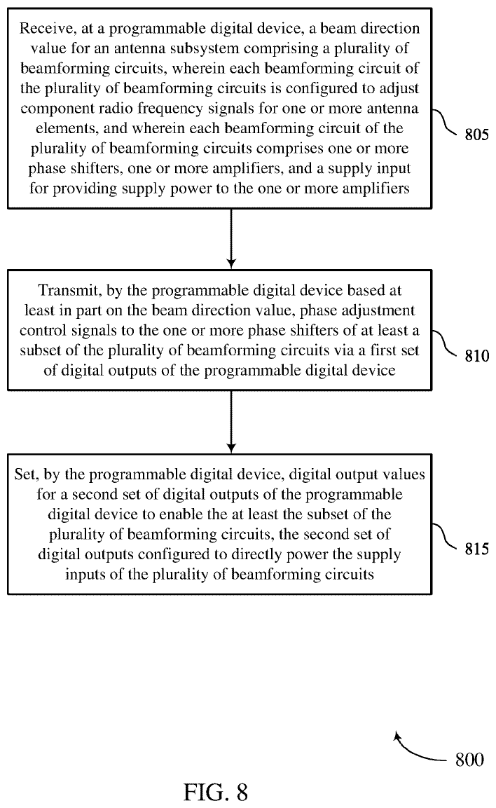

FIG. 8 shows a flowchart illustrating a method 800 that supports biasing radio frequency circuits with digital controls in accordance with aspects of the present disclosure. The operations of the method 800 may be implemented by a radio frequency circuit or its components as described herein. For example, the operations of the method 800 may be performed by a radio frequency circuit as described with reference to FIGS. 1 through 5. In some examples, a radio frequency circuit may execute a set of instructions to control the functional elements of the radio frequency circuit to perform the described functions. Additionally, or alternatively, the radio frequency circuit may perform aspects of the described functions using special-purpose hardware.

At 805, the method 800 may include receiving, at a programmable digital device, a beam direction value for an antenna subsystem including a set of multiple beamforming circuits, where each beamforming circuit of the set of multiple beamforming circuits is configured to adjust component radio frequency signals for one or more antenna elements, and where each beamforming circuit of the set of multiple beamforming circuits includes one or more phase shifters, one or more amplifiers, and a supply input for providing supply power to the one or more amplifiers. The operations of 805 may be performed in accordance with examples as disclosed herein. In some examples, aspects of the operations of 805 may be performed by a programmable digital device 110 as described with reference to FIGS. 1-5.

At 810, the method may include transmitting, by the programmable digital device based on the beam direction value, phase adjustment control signals to the one or more phase shifters of at least a subset of the set of multiple beamforming circuits via a first set of digital outputs of the programmable digital device. The operations of 810 may be performed in accordance with examples as disclosed herein. In some examples, aspects of the operations of 810 may be performed by a digital output manager 630 as described with reference to FIG. 6.

At 815, the method may include setting, by the programmable digital device, digital output values for a second set of digital outputs of the programmable digital device to enable the at least the subset of the set of multiple beamforming circuits, the second set of digital outputs configured to directly power the supply inputs of the set of multiple beamforming circuits. The operations of 815 may be performed in accordance with examples as disclosed herein. In some examples, aspects of the operations of 815 may be performed by a digital output manager 630 as described with reference to FIG. 6.

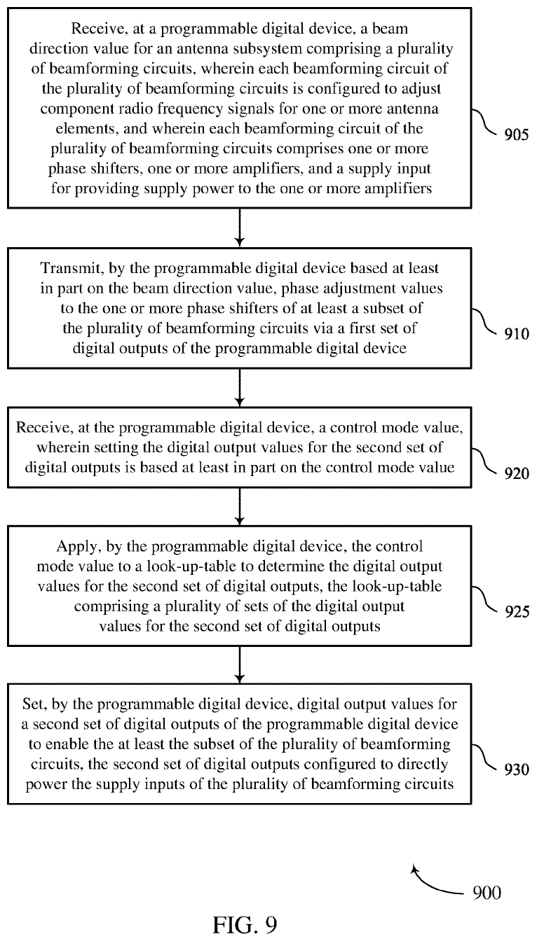

FIG. 9 shows a flowchart illustrating a method 900 that supports biasing radio frequency circuits with digital controls in accordance with aspects of the present disclosure. The operations of the method 900 may be implemented by a radio frequency circuit or its components as described herein. For example, the operations of the method 900 may be performed by a radio frequency circuit as described with reference to FIGS. 1 through 5. In some examples, a radio frequency circuit may execute a set of instructions to control the functional elements of the radio frequency circuit to perform the described functions. Additionally, or alternatively, the radio frequency circuit may perform aspects of the described functions using special-purpose hardware.

At 905, the method 900 may include receiving, at a programmable digital device, a beam direction value for an antenna subsystem including a set of multiple beamforming circuits, where each beamforming circuit of the set of multiple beamforming circuits is configured to adjust component radio frequency signals for one or more antenna elements, and where each beamforming circuit of the set of multiple beamforming circuits includes one or more phase shifters, one or more amplifiers, and a supply input for providing supply power to the one or more amplifiers. The operations of 905 may be performed in accordance with examples as disclosed herein. In some examples, aspects of the operations of 905 may be performed by a programmable digital device 625 as described with reference to FIG. 6.

At 910, the method 900 may include transmitting, by the programmable digital device based on the beam direction value, phase adjustment control signals to the one or more phase shifters of at least a subset of the set of multiple beamforming circuits via a first set of digital outputs of the programmable digital device. The operations of 910 may be performed in accordance with examples as disclosed herein. In some examples, aspects of the operations of 910 may be performed by a digital output manager 630 as described with reference to FIG. 6.

At 915, the method 900 may include receiving, at the programmable digital device, a control mode value, where setting the digital output values for the second set of digital outputs is based on the control mode value. The operations of 915 may be performed in accordance with examples as disclosed herein. In some examples, aspects of the operations of 915 may be performed by a control mode manager 635 as described with reference to FIG. 6.

At 920, the method 900 may include applying, by the programmable digital device, the control mode value to a look-up-table to determine the digital output values for the second set of digital outputs, the look-up-table including a set of multiple sets of the digital output values for the second set of digital outputs. The operations of 920 may be performed in accordance with examples as disclosed herein. In some examples, aspects of the operations of 920 may be performed by a control mode manager 635 as described with reference to FIG. 6.

At 925, the method may include setting, by the programmable digital device, digital output values for a second set of digital outputs of the programmable digital device to enable the at least the subset of the set of multiple beamforming circuits, the second set of digital outputs configured to directly power the supply inputs of the set of multiple beamforming circuits. The operations of 925 may be performed in accordance with examples as disclosed herein. In some examples, aspects of the operations of 925 may be performed by a digital output manager 630 as described with reference to FIG. 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An antenna subsystem, comprising:
a plurality of beamforming circuits, wherein each beamforming circuit of the plurality of beamforming circuits is configured to adjust component radio frequency signals for one or more antenna elements, and wherein each beamforming circuit of the plurality of beamforming circuits comprises one or more phase shifters, one or more amplifiers, and a supply input for providing supply power to the one or more amplifiers; and
a programmable digital device comprising:
a beam steering input configured to receive a beam direction value;
a control mode input configured to receive a control mode value for the plurality of beamforming circuits; and
a plurality of digital outputs, including:
a first set of the plurality of digital outputs configured to provide phase adjustment control signals to the one or more phase shifters of at least a subset of the plurality of beamforming circuits based at least in part on the beam direction value; and
a second set of the plurality of digital outputs configured to directly power supply inputs of the at least the subset of the plurality of beamforming circuits based at least in part on the control mode value, wherein the programmable digital device controls whether individual beamforming circuits of the at least the subset of the plurality of beamforming circuits are enabled or disabled via the second set of the plurality of digital outputs.

2. The antenna subsystem of claim 1, wherein two or more of the second set of the plurality of digital outputs are directly coupled to the supply input of a beamforming circuit of the plurality of beamforming circuits.

3. The antenna subsystem of claim 2, wherein the two or more of the second set of the plurality of digital outputs are configured to be selectively turned on or off to adjust an amplitude associated with an amplifier of the plurality of beamforming circuits.

4. The antenna subsystem of claim 1, wherein two of more of the first set of the plurality of digital outputs are directly coupled to the one or more phase shifters of at least one beamforming circuit of the plurality of beamforming circuits.

5. The antenna subsystem of claim 1, wherein the programmable digital device is further configured to control the second set of the plurality of digital outputs to disable beamforming circuits of the plurality of beamforming circuits that are not in the at least the subset of the plurality of beamforming circuits based at least in part on the control mode value.

6. The antenna subsystem of claim 5, wherein:
the programmable digital device is configured to enable the at least the subset of the plurality of beamforming circuits to communicate signals via a beam formed using antenna elements of a first portion of an antenna array associated with the at least the subset of the plurality of beamforming circuits, and
the beam is formed exclusive of antenna elements of a second portion of the antenna array associated with the beamforming circuits that are not in the at least the subset of the plurality of beamforming circuits.

7. The antenna subsystem of claim 5, wherein at least a first set of the second set of the plurality of digital outputs connected to at least a first set of the plurality of beamforming circuits are powered off.

8. The antenna subsystem of claim 1, wherein the programmable digital device is further configured to:
apply the control mode value to a look-up-table to determine digital output values for the plurality of digital outputs, the look-up-table comprising a plurality of sets of the digital output values for the plurality of digital outputs.

9. The antenna subsystem of claim 1, wherein the programmable digital device further comprises:
a storage device that is configured to store one or more look-up-tables comprising a plurality of sets of digital output values for the plurality of digital outputs corresponding to a plurality of values of the control mode value.

10. The antenna subsystem of claim 1, further comprising:
a circuit board, wherein the plurality of beamforming circuits are located on an antenna substrate that is positioned on a first side of the circuit board and the programmable digital device is located on a second side of the circuit board opposite to the first side.

11. The antenna subsystem of claim 1, wherein each beamforming circuit of the plurality of beamforming circuits comprises a control input for setting an operating point of each beamforming circuit.

12. The antenna subsystem of claim 11, wherein the control input of each beamforming circuit is tied to a common reference voltage.

13. The antenna subsystem of claim 11, wherein the control input is a gate voltage, and wherein the second set of the plurality of digital outputs connect to drain voltages.

14. The antenna subsystem of claim 1, wherein each of the plurality of digital outputs comprises a programmable impedance output driver.

15. The antenna subsystem of claim 1, wherein each of the plurality of beamforming circuits comprises a monolithic microwave integrated circuit.

16. The antenna subsystem of claim 1, wherein the programmable digital device is a monolithic integrated circuit.

17. The antenna subsystem of claim 1, wherein the programmable digital device is a complex programmable logic device or a field programmable gate array.

18. The antenna subsystem of claim 1, wherein the programmable digital device is configured to perform modulation and demodulation on one or more signals communicated via the one or more antenna elements.

19-31. (canceled)
